(19) United States
(12) Patent Application Publication
(10) Pub. No.: US 2007/0123661 A1
(43) Pub. Date: May 31, 2007

(54) Utilization of radiohardenable resins based on hydrogenated ketone and phenol aldehyde resins

(75) Inventors: Patrick Glockner, Haltern am See (DE); Lutz Mindach, Marl (DE); Peter Denkinger, Nottuln (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: Degussa AG, Duesseldorf (DE)

(21) Appl. No.: 10/588,193

(22) PCT Filed: Dec. 7, 2004
(86) PCT No.: PCT/EP04/53316

§ 371 Date: Aug. 2, 2006

(30) Foreign Application Priority Data
Feb. 3, 2004 (DE) 10 2004 005 208.5

(51) Int. Cl. C08L 61/02

(52) U.S. Cl. 525/398

(57) ABSTRACT

The invention relates to the use of radiation-curable resins based on carbonyl-hydrogenated ketone-aldehyde resins and ring-hydrogenated phenol-aldehyde resins.

The invention relates to the use of radiation-curable resins based on carbonyl-hydrogenated ketone-aldehyde and ring-hydrogenated phenol-aldehyde resins.

Radiation-curable coating materials have increasingly gained in importance within recent years, for reasons including the low VOC (volatile organic compounds) content of these systems.

The film-forming components in the coating material are of relatively low molecular mass and hence of low viscosity, so that there is no need for high fractions of organic solvents. Durable coatings are obtained by the formation, following application of the coating material, of a high molecular mass, polymeric network by means of crosslinking reactions initiated by, for example, electron beams or UV light.

Hard resins such as, for example, ketone-aldehyde resins are used in coating materials, for example, as additive resins in order to enhance certain properties such as initial drying rate, gloss, hardness or scratch resistance. Owing to their relatively low molecular weight, customary ketone-aldehyde resins possess a low melt viscosity and solution viscosity and therefore also serve as film-forming functional fillers in coating materials.

Ketone-aldehyde resins normally possess hydroxyl groups and can therefore be crosslinked only with, for example, polyisocyanates or amine resins. These crosslinking reactions are usually initiated and/or accelerated thermally.

For radiation-initiated crosslinking reactions, in accordance with cationic and/or free-radical reaction mechanisms, the ketone-aldehyde resins are not suitable.

Accordingly, the ketone-aldehyde resins are normally added to radiation-curable coating systems as, for example, a film-forming passive, i.e., noncrosslinking component. Owing to the uncrosslinked resin fractions, the resistance of such coatings to gasoline, chemicals or solvents, for example, is often relatively low.

DE 23 45 624, EP 736 074, DE 28 47 796, DD 24 0318, DE 24 38 724, and JP 09143396 describe the use of ketone-aldehyde resins and ketone resins, e.g., cyclohexanone-formaldehyde resins, in radiation-curable systems. Radiation-induced crosslinking reactions of these resins are not described.

EP 0 902 065 describes the use of nonradiation-curable resins formed from urea (derivatives), ketone or aldehydes as an added component in a mixture with radiation-curable resins.

DE 24 38 712 describes radiation-curing printing inks composed of film-forming resins, ketone resins and ketone-formaldehyde resins, and polymerizable components such as polyfunctional acrylate esters of polyhydric alcohols. To the skilled worker it is obvious that radiation-induced crosslinking reaction of the modified ketone-aldehyde resins and ketone resins can only come about through the use of unsaturated fatty acids. It is known, however, that resins having a higher oil content tend toward, for example, unwanted yellowing and thus their use in high-quality coatings is limited.

U.S. Pat. No. 4,070,500 describes the use of nonradiation-curable ketone-formaldehyde resins as a film-forming component in radiation-curable inks.

The carbonyl groups have long been converted into secondary alcohols by hydrogenation of ketone-aldehyde resins (DE-C 8 70 022). A typical and known product is Kunstharz SK from Degussa AG. Likewise known are resins on a phenolic resin basis, whose aromatic units have been converted by hydrogenation into cycloaliphatic groups, with some of the hydroxyl groups being retained. The use of carbonyl- and ring-hydrogenated ketone-aldehyde resins based on ketones containing aromatic groups is likewise possible. Such a resin is described in DE 33 34 631. The OH number of such products, at more than 200 mg KOH/g, is very high.

It was an object of the present invention to find radiation-curable crosslinkable resins for use in coating materials, adhesives, inks, including printing inks, polishes, varnishes, pigment pastes and masterbatches, fillers, sealants and insulants and/or cosmetic articles which produce durable and robust coatings, seals and adhesive bonds, are insoluble after crosslinking, and possess great hardness and abrasion resistance, a high gloss, and a high stability toward hydrolysis.

Surprisingly it has been possible to achieve this object by using carbonyl-hydrogenated ketone-aldehyde resins and/or ring-hydrogenated phenol resins containing ethylenically unsaturated moieties as a main, base or additional component in radiation-curing coating materials, adhesives, inks, including printing inks, polishes, varnishes, pigment pastes and masterbatches, fillers, sealants and insulants and/or cosmetic articles.

It has been found that the use of the radiation-curable resins of the invention based on carbonyl-hydrogenated ketone-aldehyde resins and ring-hydrogenated phenol-aldehyde resins as a main, base or additional component in radiation-curing coating materials, adhesives, inks, including printing inks, polishes, varnishes, pigment pastes and masterbatches, fillers, sealants and insulants and/or cosmetic articles brings about a reduction in viscosity, thereby making it possible very largely to omit low molecular mass constituents—particularly volatile organic solvents which may possibly also contain reactive groups (and are then known as reactive diluents)—which is desirable on environmental and toxicological grounds.

The use of the radiation-curable resins of the invention based on carbonyl-hydrogenated ketone-aldehyde resins and ring-hydrogenated phenol-aldehyde resins as a main, base or additional component in radiation-curing coating materials, adhesives, inks, including printing inks, polishes, varnishes, pigment pastes and masterbatches, fillers, sealants and insulants and/or cosmetic articles results in greater gloss and greater hardness and also abrasion resistance, improved chemical resistance and solvent resistance, and very high stability toward hydrolysis at the same time.

Additionally there is an improvement in the adhesion to substrates such as metals, plastics, wood, paper, textiles, and glass, for example, and also mineral substrates, thereby enhancing the protection afforded to these substrates, through an increase in corrosion resistance, f0r example. There is also an increase in the intercoat adhesion, thereby improving the adhesion of further applied coats.

Both pigment wetting and stabilization of the pigments are improved. It is possible to achieve the same color shade and color strengths with a smaller amount of pigment if the products according to the invention are used. This is particularly advantageous not least on economic grounds, since not only high-priced pigments but also additive wetting and stabilizing agents can be at least reduced.

Particular preference is given to the use of the radiation-curable resins as a main component, base component or additional component in radiation-curing fillers, primers, surfacers, base-coat, topcoat, and clearcoat materials, particularly on metals, plastics, wood, paper, textiles and glass and also on mineral substrates. Besides the radiation-curable resins it is possible for other oligomers and/or polymers, selected from the group consisting of polyurethanes, polyesters, polyacrylates, polyolefins, natural resins, epoxy resins, silicone oils and silicone resins, amine resins, fluoro polymers, and derivatives thereof, to be present, alone or in combination. Depending on the desired properties and the nature of the application it is possible for the amount of the further oligomers and/or polymers to be between 98% and 5%.

The radiation-curable resins may also comprise auxiliaries and additives selected from inhibitors, organic solvents, with or without unsaturated moieties, surface-active substances, oxygen scavengers and/or free-radical scavengers, catalysts, light stabilizers, color brighteners, photoinitiators, photosensitizers, thixotropic agents, antiskinning agents, defoamers, dyes, pigments, fillers, and dulling agents. The amount varies greatly according to the field of use and nature of the auxiliary and additive.

The invention provides for the use of radiation-curable resins essentially comprising
A) at least one carbonyl-hydrogenated ketone-aldehyde resin
and/or
B) at least one ring-hydrogenated phenol-aldehyde resin
and
C) at least one compound comprising at least one ethylenically unsaturated moiety having at the same time at least one moiety which is reactive toward A) and/or B), as a main component, base component or additional component in radiation-curing coating materials, adhesives, inks, including printing inks, polishes, varnishes, pigment pastes and masterbatches, fillers, sealants and insulants and/or cosmetic articles.

The invention also provides for the use of radiation-curable resins obtained by polymer-analogously reacting
A) at least one carbonyl-hydrogenated ketone-aldehyde resin
and/or
B) at least one ring-hydrogenated phenol-aldehyde resin
and
C) at least one compound comprising at least one ethylenically unsaturated moiety and at the same time at least one moiety which is reactive toward A) and/or B), as a main component, base component or additional component in radiation-curing coating materials, adhesives, inks, including printing inks, polishes, varnishes, pigment pastes and masterbatches, fillers, sealants and insulants and/or cosmetic articles.

The text below describes in more detail the radiation-curable resins of the invention based on carbonyl-hydrogenated ketone-aldehyde resins and ring-hydrogenated phenol-aldehyde resins.

Suitable ketones for preparing the carbonyl-hydrogenated ketone-aldehyde resins (component A) include all ketones, especially acetone, acetophenone, methyl ethyl ketone, tert-butyl methyl ketone, heptan-2-one, pentan-3-one, methyl isobutyl ketone, cyclopentanone, cyclododecanone, mixtures of 2,2,4- and 2,4,4-trimethylcyclopentanone, cycloheptanone and cyclooctanone, cyclohexanone and all alkyl-substituted cyclohexanones having one or more alkyl radicals containing in total 1 to 8 carbon atoms, individually or in a mixture. Examples that may be mentioned of alkyl-substituted cyclohexanones include 4-tert-amylcyclohexanone, 2-sec-butylcyclohexanone, 2-tert-butylcyclohexanone, 4-tert-butylcyclohexanone, 2-methylcyclohexanone, and 3,3,5-trimethylcyclohexanone.

In general, however, any of the ketones said in the literature to be suitable for ketone resin syntheses, more generally all C—H-acidic ketones, can be used. Preference is given to carbonyl-hydrogenated ketone-aldehyde resins based on the ketones acetophenone, cyclohexanone, 4-tert-butylcyclohexanone, 3,3,5-trimethylcyclohexanone, and heptanone, alone or in a mixture.

Suitable aldehyde components of the carbonyl-hydrogenated ketone-aldehyde resins (component A) include in principle linear or branched aldehydes, such as formaldehyde, acetaldehyde, n-butyraldehyde and/or isobutyraldehyde, valeraldehyde, and dodecanal. In general it is possible to use any of the aldehydes said in the literature to be suitable for ketone resin syntheses. It is preferred, however, to use formaldehyde, alone or in mixtures.

The requisite formaldehyde is normally used in the form of an aqueous or alcoholic (e.g., methanol or butanol) solution with a strength of from about 20 to 40% by weight. Other forms of formaldehyde, such as para-formaldehyde or trioxane, for example, are likewise possible. Aromatic aldehydes, such as benzaldehyde, can likewise be present in a mixture with formaldehyde.

Particularly preferred starting compounds used for the component A) carbonyl-hydrogenated resins are acetophenone, cyclohexanone, 4-tert-butylcyclohexanone, 3,3,5-trimethylcyclo-hexanone, and heptanone, alone or in a mixture, and formaldehyde.

The resins of ketone and aldehyde are hydrogenated with hydrogen in the presence of a catalyst at pressures of up to 300 bar. In the course of the hydrogenation the carbonyl group of the ketone-aldehyde resin is converted into a secondary hydroxyl group. Depending on reaction conditions, some of the hydroxyl groups may be eliminated, resulting in methylene groups. This is illustrated in the following scheme:

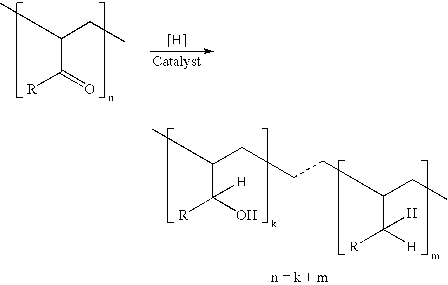

As component B) use is made of ring-hydrogenated phenol-aldehyde resins of the novolak type using the aldehydes such as formaldehyde, butyraldehyde or benzaldehyde, for example, preferably formaldehyde. To a minor extent it is possible to use nonhydrogenated novolaks, but these then have lower light fastnesses.

Particularly suitable are ring-hydrogenated resins based on alkyl-substituted phenols. In general it is possible to use any of the phenols said in the literature to be suitable for phenolic resin syntheses.

Examples of suitable phenols that may be mentioned include phenol, 2- and 4-tert-butylphenol, 4-amylphenol, nonylphenol, 2- and 4-tert-octylphenol, dodecylphenol, cresol, xylenols, and bisphenols. They can be used alone or in a mixture.

It is particularly preferred to use ring-hydrogenated, alkyl-substituted phenol-formaldehyde resins of the novolak type. Preferred phenolic resins are reaction products of formaldehyde and 2- and 4-tert-butylphenol, 4-amylphenol, nonylphenol, 2- and 4-tert-octylphenol, and dodecylphenol.

The novolaks are hydrogenated with hydrogen in the presence of a suitable catalyst. Through the choice of the catalyst the aromatic ring is converted into a cycloaliphatic ring. Through a suitable choice of the parameters the hydroxyl group are retained.

This is illustrated by the following scheme:

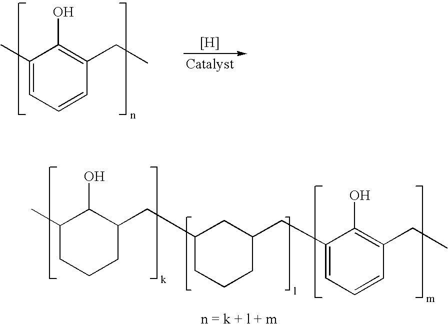

Through the choice of the hydrogenation conditions it is also possible for the hydroxyl groups to be hydrogenated, thereby giving rise to cycloaliphatic rings. The ring-hydrogenated resins possess OH numbers of from 50 to 450 mg KOH/g, preferably from 100 to 350 mg KOH/g, more preferably from 150 to 300 mg KOH/g. The fraction of aromatic groups is below 50% by weight, preferably below 30% by weight, more preferably below 10% by weight.

The radiation-curable resins on which the invention is based are obtained by polymer-analogous reaction of the hydrogenated ketone-aldehyde resins and/or of the phenol-aldehyde resins, in the melt or in a suitable solvent solution, with component C). Suitability as component C) is possessed by maleic anhydride, (meth)acrylic acid derivatives such as (meth)acryloyl chloride, glycidyl(meth)acrylate, (meth)acrylic acid and/or the low molecular mass alkyl esters and/or anhydrides thereof, alone or in a mixture. It is also possible to obtain radiation-curable resins by reacting the hydrogenated ketone-aldehyde resins and phenol-aldehyde resins with isocyanates possessing an ethylenically unsaturated moiety, such as (meth)acryloyl isocyanate, α,α-dimethyl-3-isopropenylbenzyl isocyanate, (meth)acryloylalkyl isocyanate with alkyl spacers possessing from 1 to 12, preferably from 2 to 8, more preferably from 2 to 6 carbon atoms, such as methacryloylethyl isocyanate and methacryloylbutyl isocyanate, for example. Further reaction products which have proven suitable are those of hydroxyalkyl(meth)acrylates whose alkyl spacers have from 1 to 12, preferably from 2 to 8, more preferably from 2 to 6 carbon atoms and diisocyanates such as, for example, cyclohexane diisocyanate, methylcyclohexane diisocyanate, ethylcyclohexane diisocyanate, propylcyclohexane diisocyanate, methyldiethylcyclohexane diisocyanate, phenylene diisocyanate, tolylene diisocyanate, bis(isocyanatophenyl)methane, propane diisocyanate, butane diisocyanate, pentane diisocyanate, hexane diisocyanate, such as hexamethylene diisocyanate (HDI) or 1,5-diisocyanato-2-methylpentane (MPDI), heptane diisocyanate, octane diisocyanate, nonane diisocyanate, such as 1,6-diisocyanato-2,4,4-trimethylhexane or 1,6-diisocyanato-2,2,4-trimethylhexane (TMDI), nonane triisocyanate, such as 4-isocyanatomethyloctane 1,8-diisocyanate (TIN), decane di- and triisocyanate, undecane di- and triisocyanate, dodecane di- and triisocyanates, isophorone diisocyanate (IPDI), bis(isocyanatomethylcyclohexyl)methane (H₁₂MDI), isocyanatomethylmethylcyclohexyl isocyanate, 2,5(2,6)-bis(isocyanatomethyl)bicyclo[2.2.1]heptane (NBDI), 1,3-bis(iso-cyanatomethyl)cyclohexane (1,3-H₆-XDI) or 1,4-bis(isocyanatomethyl)cyclohexane (1,4-H₆-XDI), alone or in a mixture. Examples that may be mentioned include the reaction products in a 1:1 molar ratio of hydroxyethyl acrylate and/or hydroxyethyl methacrylate with isophorone diisocyanate and/or H₁₂MDI and/or HDI.

Another preferred class of polyisocyanates are the compounds having more than two isocyanate groups per molecule which are prepared by trimerizing, allophanatizing, biuretizing and/or urethaneizing the simple diisocyanates, examples being the reaction products of these simple diisocyanates, such as IPDI, HDI and/or H₁₂MDI, for example, with polyhydric alcohols (e.g., glycerol, trimethylolpropane, pentaerythritol) and/or polyfunctional polyamines or else the triisocyanurates obtainable by trimerizing the simple diisocyanates, such as IPDI, HDI, and H₁₂MDI, for example.

If desired it is possible to use a suitable catalyst for preparing the resins of the invention. Suitable compounds are all those known in the literature which accelerate an OH—NCO reaction, such as diazabicyclooctane (DABCO) or dibutyltin dilaurate (DBTL) for example.

The functionality of the resins obtained ranges from low to high in accordance with the ratio of the reactants to one another. Through the choice of reactants it is also possible to set the subsequent hardness of the crosslinked film. If, for example, a hard resin such as hydrogenated-formaldehyde resin is reacted with α,α-dimethyl-3-isopropenylbenzyl isocyanate, the resulting products are harder than those obtained through the use of (meth)acryloylethyl isocyanate and/or hydroxyethyl acrylate-isophorone diisocyanate adducts; the flexibility, however, is then lower. It has also been found that the reactivity of ethylenically unsaturated compounds with little steric hindrance—such as of hydroxyethyl acrylate, for example—is higher than in the case of those which are sterically hindered, such as α,α-dimethyl-3-isopropenylbenzyl isocyanate, for example.

It is also possible to replace some of the carbonyl-hydrogenated ketone-aldehyde resins A) and/or ring-hydrogenated phenol-aldehyde resins B) by further hydroxy-functionalized polymers such as hydroxy-functional polyethers, polyesters and/or polyacrylates, for example. In this case, mixtures of these polymers with the ketone-aldehyde resins and/or phenol-aldehyde resins can be reacted polymer-analogously with component C). It has been found that first of all it is also possible to prepare adducts of the ketone-aldehyde resins and/or phenol-aldehyde resins with, for example, hydroxy-functional polyethers, polyesters and/or polyacrylates using the abovementioned diisocyanates and/or triisocyanates, and only then are these adducts reacted polymer-analogously with component C). In contrast to the “plain” carbonyl-hydrogenated ketone-aldehyde resins and/or ring-hydrogenated phenol-aldehyde resins it is possible by this means better to set properties such as flexibility and hardness, for example. The further hydroxy-functional polymers generally possess molecular weights Mn of between 200 and 10 000 g/mol, preferably between 300 and 5 000 g/mol.

The resins on which the invention is based are prepared in the melt or in a suitable, organic solvent solution of the carbonyl-hydrogenated ketone-aldehyde resins and/or ring-hydrogenated phenol-aldehyde resins.

Said organic solvent may if desired likewise possess unsaturated moieties, in which case it acts directly as a reactive diluent in the subsequent application.

For this purpose, in one preferred embodiment I, the compound comprising at least one ethylenically unsaturated moiety and at the same time at least one moiety which is reactive toward A) and/or B), in the presence if desired of a suitable catalyst, is added to the solution or melt of the carbonyl-hydrogenated ketone-aldehyde resin A) and/or ring-hydrogenated phenol-aldehyde resin B).

The temperature of the reaction is selected in accordance with the reactivity of component C). Where isocyanates are used as component C), suitable temperatures have been found to be between 30 and 150° C., preferably between 50 and 140° C.

The solvent that may be present can be separated off if desired after the end of the reaction, in which case a powder of the product of the invention is generally obtained.

It has proven advantageous to react 1 mol of the carbonyl-hydrogenated ketone-aldehyde resin and/or ring-hydrogenated phenol-aldehyde resin—based on Mn—with from 0.5 to 15 mol, preferably from 1 to 10 mol, in particular from 2 to 8 mol of the unsaturated compound (component C).

In a preferred embodiment II the compound comprising at least one ethylenically unsaturated moiety and at the same time at least one moiety which is reactive toward A) and/or B) and the additional polymer, in the presence if desired of a suitable catalyst, is added to the solution or melt of the carbonyl-hydrogenated ketone-aldehyde resin A) and/or ring-hydrogenated phenol-aldehyde resin B) and the hydroxy-functional polymer, such as polyether, polyester and/or polyacrylate, for example.

The temperature of the reaction is selected in accordance with the reactivity of component C). Where isocyanates are used as component C), suitable temperatures have been found to be between 30 and 150° C., preferably between 50 and 140° C.

The solvent that may be present can be separated off if desired after the end of the reaction, in which case a powder of the product of the invention is generally obtained.

It has proven advantageous to react 1 mol of the carbonyl-hydrogenated ketone-aldehyde resins and/or ring-hydrogenated-phenol-aldehyde resins and/or additional polymers—based on Mₙ—with from 0.5 to 15 mol, preferably from 1 to 10 mol, in particular from 2 to 8 mol of the unsaturated compound (component C).

In a preferred embodiment III a di- and/or trifunctional isocyanate is added to the solution or melt of the carbonyl-hydrogenated ketone-aldehyde resin A) and/or ring-hydrogenated phenol-aldehyde resin B) and the hydroxy-functional polymer, such as polyether, polyester and/or polyacrylate, for example, and a hydroxy-functional preadduct is prepared. Only then is the compound comprising at least one ethylenically unsaturated moiety and at the same time at least one moiety which is reactive toward A) and/or B) and the additional polymer, in the presence if desired of a suitable catalyst, added.

The temperature of the reaction is selected in accordance with the reactivity of component C). Where isocyanates are used as component C), suitable temperatures have been found to be between 30 and 150° C., preferably between 50 and 140° C.

The solvent that may be present can be separated off if desired after the end of the reaction, in which case a powder of the product of the invention is generally obtained.

It has proven advantageous to react 1 mol of component A) and/or component B) and/or additional polymers—based on Mₙ—with from 0.5 to 15 mol, preferably from 1 to 10 mol, in particular from 2 to 8 mol of the unsaturated compound (component C).

In the presence of suitable photoinitiators, and in the presence if desired of suitable photosensitizers, these resins can be converted by irradiation into polymeric, insoluble networks which, depending on the level of ethylenically unsaturated groups present, produce elastomers to thermosets.

The examples which follow are intended to illustrate the invention made but not to restrict its scope of application:

### EXAMPLE 1 (UV 17)

Synthesis takes place by reaction of 1 mol of Kunstharz SK (Degussa AG; hydrogenated resin formed from acetophenone and formaldehyde; OHN=240 mg KOH/g (acetic anhydride method), Mn˜1000 g/mol) with 1.5 mol of a reaction product of IPDI and hydroxyethyl acrylate in a ratio of 1:1 in the presence of 0.2% (on resin) of 2,6-bis(tert-butyl)-4-methylphenol (Ralox BHT, Degussa AG) and 0.1% (on resin) of dibutyltin dilaurate, 65% strength in methoxypropyl acetate, at 80° C. under nitrogen in a three-necked flask with stirrer, reflux condenser, and temperature sensor until an NCO number of less than 0.1 is reached. The pale, clear solution obtained possesses a dynamic viscosity of 51.56 Pa·s.

### EXAMPLE 2 (UV 19)

The reaction is carried out of 1 mol of Kunstharz SK (Degussa AG; OHN=240 mg KOH/g (acetic anhydride method), Mn˜1000 g/mol) and 4 mol of a reaction product of IPDI and hydroxyethyl acrylate in a ratio of 1:1 in the presence of 0.2% (on resin) of 2,6-bis(tert-butyl)-4-methylphenol (Degussa AG) and 0.1% (on resin) of dibutyltin dilaurate, 65% strength in methoxypropyl acetate, at 80° C. under nitrogen in a three-necked flask with stirrer, reflux condenser, and temperature sensor until an NCO number of less than 0.1 is reached. The pale, clear solution obtained possesses a dynamic viscosity of 26.2 Pa·s.

### USE EXAMPLES

The base resin (UV 20) used was an adduct of trimethylolpropane, IPDI, Terathane 650 and hydroxyethyl acrylate, as a 70% strength solution in MOP acetate, viscosity at 23° C.=19.2 Pas.

Also investigated, for comparison, was the physically admixed, noncrosslinking Kunstharz SK.

Viscosities of the Different Systems in 50% Form in MOP Acetate without Photoinitiator

| | Mixing ratio | Dyn. viscosity |
|---|---|---|
| Number | solids | 23° C. |
| Single-substance | | |
| systems | | |
| 481 | A-UV 20 | 775 mPas |
| 478 | A-UV 17 | 430 mPas |
| 480 | A-UV 19 | 370 mPas |
| Mixtures | | |
| 494 | A-UV 20:Kunstharz SK = 95:5 | 760 mPas |
| 495 | A-UV 20:Kunstharz SK = 90:10 | 750 mPas |
| 482 | A-UV 20:A-UV 17 = 95:5 | 740 mPas |
| 483 | A-UV 20:A-UV 17 = 90:10 | 720 mPas |
| 484 | A-UV 20:A-UV 17 = 80:20 | 670 mPas |
| 488 | A-UV 20:A-UV 19 = 95:5 | 750 mPas |
| 489 | A-UV 20:A-UV 19 = 90:10 | 710 mPas |
| 490 | A-UV 20:A-UV 19 = 80:20 | 650 mPas |

As the proportion of the products of the invention goes up there is a fall in the dynamic viscosity of the formulations.

Summary of the Coatings Data Obtained

Darocure 1173 (for amount see table) was added to the mixtures and they were drawn down onto metal panels using a doctor blade. The systems contain solvent; therefore initial drying was carried out in a forced-air oven at 80° C. for 30 minutes. The films were then cured by means of UV light (medium-pressure mercury lamp, 70 W/optical filter 350 nm) (3×6 s).

| | Resin mix. | 1173 | | UV- | Coatings data | | | | | | | | |
|---|---|---|---|---|---|---|---|---|---|---|---|---|---|
| Coating | based on | [% based | NVC | curing | | CH/ | | | | | Peugeot | MEK | |
| No. | resin | on resin] | [%] | Mini-Cure | FT μ | Tesa | HB | EC | HK | BI | test | test | Flow |
| 481 | A-UV 20 | 1.50 | 50.4 | 6″ | n.m. too soft, sticks readily | | | | | | | | minimally |
| | Standard | | | | | | | | | | | | restless surf. |
| | | | | 2 × 6″ | 31-39 | 2B/ | n.m. | n.m. | 38 | >80 dir | o | >150 ++ | |
| | | | | | | 5B | | | | >80 rev | | | |
| | | | | 3 × 6″ | 30-39 | 1B/ | n.m. | n.m. | 53 | >80 dir | o/+ | >150 ++ | |
| | | | | | | 5B | | | | >80 rev | | | |
| 481 B | A-UV 20 | 3.00 | 50.7 | 6″ | n.m. sticks | | | | 46 | | | | minimally |
| | | | | | readily | | | | | | | | restless surf. |
| | | | | 2 × 6″ | 28-36 | 5B | 71 | 10 | 48 | >80 | o | >150 ++ | |
| | | | | 3 × 6″ | 30-38 | 5B | 67 | >9 | 45 | >80 | o | >150 ++ | |
| 478 | A-UV 17 | 1.50 | 50.4 | 6″ | 32-38 | 5B | n.m. | <0.5 | 192 | <10 | ++ | 39 | slightly |
| | | | | | | | | | | | | | restless surf. |
| | | | | 2 × 6″ | 32-42 | 4-5B/ | n.m. | <0.5 | 201 | <10 | ++ | 64 | |
| | | | | | | 5B | | | | | | | |
| | | | | 3 × 6″ | 33-47 | 4-5B/ | 111 | <0.5 | 203 | <10 | ++ | 140 | |
| | | | | | | 5B | | | | | | | |
| 480 | A-UV 19 | 1.50 | 50.4 | 6″ | 35-38 | 4-5B/ | n.m. | <0.5 | 194 | <10 | ++ | 120 | slightly |
| | | | | | | 5B | | | | | | | restless surf. |
| | | | | 2 × 6″ | 35-38 | 4-5B/ | 143 | <0.5 | 202 | <10 | ++ | >150 ++ | |
| | | | | | | 5B | | | | | | | |
| | | | | 3 × 6″ | 34-39 | 4-5B/ | 143 | <0.5 | 200 | <10 | ++ | >150 ++ | |
| | | | | | | 5B | | | | | | | |
| 494 | A-UV 20 95 | 1.50 | 50.4 | 3 × 6″ | 28-33 | 0-1B/ | 71 | 9/ | 48 | >80 | o/+ | >150 o | minimally |
| | Kunsth. SK 5 | | | | | 5B | | >9.5 | | | | | restless surf. |
| 495 | A-UV 20 90 | 1.50 | 50.4 | 3 × 6″ | 30-38 | 0B/ | 71 | 9/ | 59 | >80 | o/+ | >150 (135) | minimally |
| | Kunsth. SK 10 | | | | | 5B | | >9.5 | | | | ++ | restless surf. |

1173: Darocur 1173

Physical admixing of the unsubstituted resins already improves hardness, adhesion and the Peugeot and MEK tests. Mechanical properties, as can be determined by the impact test and Erichsen cupping, are impaired, however.

| | Resin mix. | 1173 | | UV- | Coatings data | | | | | | | | |
|---|---|---|---|---|---|---|---|---|---|---|---|---|---|
| Coating | based on | [% based | NVC | curing | | CH/ | | | | | Peugeot | MEK | |
| No. | resin | on resin | [%] | Mini-Cure | FT μ | Tesa | HB | EC | HK | BI | test | test | Flow |
| 482 | A-UV 20 95 | 1.50 | 50.4 | 3 × 6″ | 30-37 | 0-1B/ | 71 | 9 | 78 | >80 | ++ | >150 o/+ | slightly |
| | A-UV 17 5 | | | | | 5B | | | | | | | restless surf. |
| 483 | A-UV 20 90 | 1.50 | 50.4 | 3 × 6″ | 30-33 | 0B/ | 77 | 10 | 101 | >80 | ++ | >150 +/++ | minimally |
| | A-UV 17 10 | | | | | 5B | | | | | | | restless surf. |
| | | | | 3 × 6″ | 31-33 | Film removed from glass prior to measurement | | | | | | | |
| 484 | A-UV 20 80 | 1.50 | 50.4 | 3 × 6″ | 30-36 | 0-1B/ | 91 | 8.5/9 | 146 | >80 | ++ | >150 +/++ | okay |
| | A-UV 17 20 | | | | | 5B | | | | | | | |
| | | | | 3 × 6″ | 31-32 | Film removed from glass prior to measurement | | | | | | | |
| 488 | A-UV 20 95 | 1.50 | 50.4 | 3 × 6″ | 31-38 | 0-1B/ | 71 | 10 | 66 | >80 | o/+ | >150 ++ | minimally |
| | A-UV 19 5 | | | | | 5B | | | | | | | restless surf. |
| 489 | A-UV 20 90 | 1.50 | 50.4 | 3 × 6″ | 28-38 | 0B/ | 77 | 9.5 | 84 | >80 | o/+ | >150 ++ | minimally |
| | A-UV 19 10 | | | | | 5B | | | | | | | restless surf. |
| | | | | 3 × 6″ | 29-37 | 0-1B/ | 83 | 9 | 75 | >80 | o | >150(121) | |
| | | | | | | 5B | | >9.5 | | | | ++ | |
| 490 | A-UV 20 80 | 1.50 | 50.4 | 3 × 6″ | 32-38 | 1-2B/ | 91 | 7.5/7 | 147 | >80 | ++ | >150 −/−− | minimally |
| | A-UV 19 20 | | | | | 5B | | | | | | | restless surf. |

1173: Darocur 1173

Chemical crosslinking of the products of the invention with the clear coating material increases the hardness and the adhesion. The premium-grade gasoline resistance (Peugeot test) and solvent resistance (MEK test) are likewise improved. Mechanical properties which were impaired in the case of the purely physical admixtures are likewise improved, which is manifested in good values for impact test and Erichsen cupping.

Yellowness Index

The investigations were made on the free film. Darocur 1173 was added to the mixtures and then drawn down onto glass, dried at 80° C. for 30 minutes, and irradiated three times for 6 s. The base line Yi value of the substrate is 0.08.

| | | Synthetic resin | | | | | |
|---|---|---|---|---|---|---|---|
| | | content | | | | | |
| | Resins | [% based on | FT | Yi values | | | |
| Coating No. | Solids | resin] | μ | Initial | 1 h 120° C. | 1 h 160° C. | 1 h 200° C. |

Blending with plain synthetic resins

| | | | | | | | |
|---|---|---|---|---|---|---|---|
| 481 | A-UV 20 | — | 31-32 | 0.4 | 0.4 | 1.7 | 50.4 |
| | | | | | | | 24-27μ |
| 494 | A-UV 20 95 | 5.0 | 31-34 | 0.2 | 0.3 | 2.7 | 40.4 |
| | Kunsth. SK | 5 | | | | | |
| 495 | A-UV 20 90 | 10.0 | 31-34 | 0.3 | 0.4 | 1.7 | 36.3 |
| | Kunsth. SK 10 | | | | | | |

Blending with synthetic resin A adduct

| | | | | | | | |
|---|---|---|---|---|---|---|---|
| 482 | A-UV 20 95 | 3.0 | 30-32 | 0.2 | 0.4 | 1.2 | 44.6 |
| | A-UV 17 5 | | | | | | 25-28μ |
| 483 | A-UV 20 90 | 5.9 | 31-33 | 0.5 | 0.5 | 2 | 38 |
| | A-UV 17 10 | | | | | | 27-31μ |
| 484 | A-UV 20 80 | 11.8 | 31-32 | 0.2 | 0.5 | 2.5 | 28.6 |
| | A-UV 17 20 | | | | | | |
| 488 | A-UV 20 95 | 1.8 | 30-32 | 0.2 | 0.3 | 1.6 | 40.4 |
| | A-UV 19 5 | | | | | 28-31μ | 27-30μ |
| 489 | A-UV 20 90 | 3.5 | 30-32 | 0.2 | 0.3 | 2.5 | 42.2 |
| | A-UV 19 10 | | | | | | 26-29μ |
| 490 | A-UV 20 80 | 7.0 | 30-32 | 0.2 | 0.3 | 2.2 | 33.5 |
| | A-UV 19 20 | | | | | | 28-30μ |

B = twice the amount of Darocur 1173 (see coatings data)

The yellowing tendency is improved as compared with the standard system, particularly in the case of exposure to high temperatures.

Abbreviations

DBTL: dibutyltin dilaurate
EC: Erichsen cupping
HB: Buchholz hardness
HK: K6nig pendulum hardness
IPDI: isophorone diisocyanate
BI: ball impact
MEK test: resistance to butanone
MOP acetate: methoxypropyl acetate
NVC: nonvolatile constituents
Peugeot test: premium-grade gasoline resistance
FT: film thickness

1. A method of using as a main component, base component or additional component in radiation-curing coating materials, adhesives, inks, including printing inks, polishes, varnishes, pigment pastes and masterbatches, fillers, sealants and insulants and/or cosmetic articles a radiation-curable resin essentially comprising at least one of
A) a carbonyl-hydrogenated ketone-aldehyde resin and
B) a ring-hydrogenated phenol-aldehyde resin
and
C) at least one compound comprising at least one ethylenically unsaturated moiety having at least one moiety which is reactive toward A) and/or B).

2. A method of using as a main component, base component or additional component in radiation-curing coating materials, adhesives, inks, including printing inks, polishes, varnishes, pigment pastes and masterbatches, fillers, sealants and insulants and/or cosmetic articles a radiation-curable resin obtained by polymer-analogously reacting at least one of
A) a carbonyl-hydrogenated ketone-aldehyde resin and
B) a ring-hydrogenated phenol-aldehyde resin
with
C) at least one compound comprising at least one ethylenically unsaturated moiety and at least one moiety which is reactive toward A) and/or B).

3. The method as claimed in claim 1, obtained by polymer-analogously reacting at least one of
A) at least one a carbonyl-hydrogenated ketone-aldehyde resin and
B) at least one a ring-hydrogenated phenol-aldehyde resin
with
C) at least one compound comprising at least one ethylenically unsaturated moiety and at least one moiety which is reactive toward A) and/or B).
and at least one hydroxyl-functionalized polymer.

4. The method as claimed in claim 3, wherein said hydroxy-functionalized polymers are selected from the group consisting of polyethers, polyesters and/or polyacrylates.

5. The method as claimed in claim 3, wherein mixtures of said hydroxy-functionalized polymers with the ketone-aldehyde resins A) and/or phenol-aldehyde resins B) are reacted polymer-analogously with component C).

6. The method as claimed in claim 3, wherein adducts of the ketone-aldehyde resins A) and/or phenol-aldehyde resins B) with said hydroxy-functionalized polymers, comprising suitable di- and/or triisocyanates, are initially prepared, and these adducts are thereafter reacted polymer-analogously with component C).

7. The use method as claimed in claim 1, wherein the ketone of component A) comprises C—H-acidic ketones.

8. The method as claimed in claim 1, wherein the starting compounds, alone or in mixtures, in the carbonyl hydrogenated ketone aldehyde resins of component A) are ketones selected from the group consisting of acetone, acetophenone, methyl ethyl ketone, heptan-2-one, pentan-3-one, methyl isobutyl ketone, tert-butyl methyl ketone, cyclopentanone, cyclododecanone, mixtures of 2,2,4- and 2,4,4-trimethylcyclopentanone, cycloheptanone, cyclooctanone, and cyclohexanone.

9. The method as claimed in claim 1, wherein the starting compounds, alone or in mixtures, in the carbonyl hydrogenated ketone aldehyde resins of component A) are alkyl-substituted cyclohexanones having one or more alkyl radicals containing in total 1 to 8 carbon atoms.

10. The method as claimed in claim 9, wherein said alkyl-substituted cyclohexanones are selected from the group consisting of 4-tert-amylcyclohexanone, 2-sec-butylcyclohexanone, 2-tert-butylcyclohexanone, 4-tert-butylcyclohexanone, 2-methylcyclohexanone, and 3,3,5-trimethylcyclohexanone.

11. The method as claimed in claim 1, wherein the ketone component of the carbonyl-hydrogenated ketone-aldehyde resins in component A) are selected from the group consisting of acetophenone, cyclohexanone, 4-tert-butylcyclohexanone, 3,3,5-trimethyl-cyclohexanone, and heptanone, alone or in a mixture.

12. The method as claimed in claim 1, wherein the aldehyde component of the carbonyl-hydrogenated ketone-aldehyde resins in component A) is selected from the group consisting of formaldehyde, acetaldehyde, n-butyraldehyde and/or isobutyraldehyde, valeraldehyde, and dodecanal, alone or in mixtures.

13. The method as claimed in claim 12, wherein the aldehyde component of the carbonyl-hydrogenated ketone-aldehyde resins in component A) is formaldehyde and/or paraformaldehyde and/or trioxane.

14. The method as claimed in claim 1, wherein component A) comprises hydrogenation products of the resins formed from formaldehyde and a ketone selected from the group consisting of acetophenone, cyclohexanone, 4-tert-butylcyclohexanone, 3,3,5-trimethylcyclohexanone, and heptanone, alone or in a mixture.

15. The method as claimed in claim 1, wherein the aldehydes of the ring-hydrogenated phenol-aldehyde resins of component B) are selected from the group consisting of formaldehyde, butyraldehyde and benzaldehyde.

16. The method as claimed in claim 1, wherein nonhydrogenated phenol-aldehyde resins are used to a minor extent.

17. The method as claimed claim 1, wherein component B) comprises ring-hydrogenated resins based on alkyl-substituted phenols.

18. The method as claimed in claim 17, wherein said alkyl-substituted phenols are selected from the group consisting of 4-tert-butylphenol, 4-amylphenol, nonylphenol, tert-octylphenol, dodecylphenol, cresol, xylenols, and bisphenols, alone or in mixtures.

19. The method as claimed in claim 1, wherein component C) comprises maleic acid.

20. The method as claimed in claim 1, wherein component C) comprises (meth)acrylic acid and/or its derivatives.

21. The method as claimed in claim 20, wherein component C) comprises (meth)acryloyl chloride, glycidyl(meth)acrylate, (meth)acrylic acid and/or the low molecular mass alkyl esters and/or anhydrides thereof, alone or in a mixture.

22. The method as claimed in claim 1, wherein component C) comprises isocyanates which possess an ethylenically unsaturated moiety selected from the group consisting of (meth)acryloyl isocyanate, α,60 -dimethyl-3-isopropenylbenzyl isocyanate, (meth)acryloylalkyl isocyanate with alkyl spacers possessing 1 to 12 carbon atoms, methacryloylethyl isocyanate and methacryloylbutyl isocyanate.

23. The method as claimed in claim 1, wherein component C) comprises reaction products of hydroxyalkyl(meth)acrylates whose alkyl spacers possess 1 to 12 carbon atoms with diisocyanates.

24. The method as claimed in claim 23, wherein said diisocyanates are selected from the group consisting of cyclohexane diisocyanate, methylcyclohexane diisocyanate, ethylcyclohexane diisocyanate, propylcyclohexane diisocyanate, methyldiethylcyclohexane diisocyanate, phenylene diisocyanate, tolylene diisocyanate, bis(isocyanatophenyl)methane, propane diisocyanate, butane diisocyanate, pentane diisocyanate, hexane diisocyanate such as, for example, hexamethylene diisocyanate (HDI) or 1,5-diisocyanato-2-methylpentane (MPDI), heptane diisocyanate, octane diisocyanate, 1,6-diisocyanato-2,4,4-trimethylhexane, 1,6-diisocyanato-2,2,4-trimethylhexane (TMDI), 4-isocyanatomethyloctane 1,8-diisocyanate (TIN), decane di- and triisocyanate, undecane di- and triisocyanate, dodecane di- and triisocyanates, isophorone diisocyanate (IPDI), bis(isocyanatomethylcyclohexyl)methane (H₁₂MDI), isocyanatomethylmethylcyclohexyl isocyanate, 2,5(2,6)-bis(isocyanatomethyl)-bicyclo[2.2.1 ]heptane (NBDI), 1,3-bis(isocyanatomethyl)cyclohexane (1,3-H₆-XDI), 1,4-bis(isocyanatomethyl)cyclohexane (1,4-H₆-XDI), alone or in mixtures.

25. The method as claimed in claim 24, wherein said diisocyanates are polyisocyanates prepared by trimerizing, allophanatizing, biuretizing and/or urethaneizing simple diisocyanates.

26. The method as claimed in claim 1, wherein component C) comprises the reaction products in a molar ratio of 1:1 of hydroxyethyl acrylate and/or hydroxyethyl methacrylate with isophorone diisocyanate and/or H₁₂MDI and/or HDI.

27. The method as claimed in claim 1, wherein said radiation-curable resin comprises 1 mol of the carbonyl-hydrogenated ketone-aldehyde resin and/or ring-hydrogenated phenol-aldehyde resin, based on Mₙ, and from 0.5 to 15 mol of the unsaturated compound.

28. The method as claimed in claim 1, wherein said radiation-curable resin is employed as a main, base or additional component in radiation-curing coating materials, primers, surfacers, basecoat materials, topcoat materials, and clearcoat materials and in radiation-curing adhesives, inks, including printing inks, polishes, varnishes, pigment pastes and masterbatches, fillers, cosmetic articles and sealants and insulants.

29. The method as claimed in claim 1 wherein said radiation-curable resin substitutes for metals, plastics, wood, paper, textiles, and glass and mineral substrates.

30. The method as claimed in claim 1, wherein additional oligomers and/or polymers are present.

31. The method as claimed in claim 30, wherein said oligomers and/or polymers are selected from the group consisting of polyurethanes, polyesters, polyacrylates, polyolefins, natural resins, epoxy resins, silicone oils and silicone resins, amine resins, fluoro polymers and derivatives thereof are present, alone or in combination.

32. The method as claimed in claim 1, wherein auxiliaries and additives are present.

33. The method as claimed in claim 32, wherein said auxiliaries and additives are selected from the group consisting of inhibitors, organic solvents, with or without unsaturated moieties, surface-active substances, oxygen scavengers and/or free-radical scavengers, catalysts, light stabilizers, color brighteners, photoinitiators, photosensitizers, thixotropic agents, antiskinning agents, defoamers, dyes, pigments, fillers and/or dulling agents.
